(19) United States
(12) Patent Application Publication
(10) Pub. No.: US 2013/0219968 A1
(43) Pub. Date: Aug. 29, 2013

(54) GLASS FINING METHOD USING PHYSICAL BUBBLER

(71) Applicants: Gilbert De Angelis, Lindley, NY (US); Megan Aurora DeLamielleure, Corning, NY (US); Guido Peters, Bath, NY (US)

(72) Inventors: Gilbert De Angelis, Lindley, NY (US); Megan Aurora DeLamielleure, Corning, NY (US); Guido Peters, Bath, NY (US)

(21) Appl. No.: 13/759,578

(22) Filed: Feb. 5, 2013

Related U.S. Application Data
(60) Provisional application No. 61/603,581, filed on Feb. 27, 2012.

(51) Int. Cl. C03B 5/225

(52) U.S. Cl. CPC C03B 5/225
USPC 65/134.4; 65/134.5

(57) ABSTRACT

A method for fining a glass melt comprises providing a glass melt in a melting vessel, moving the glass melt to a fining vessel via a first channel, and physically introducing gas bubbles to the glass melt in the fining vessel to form a fined glass, wherein the melting vessel and the fining vessel are in a horizontal orientation with respect to each other.

This application claims the benefit of priority under 35 U.S.C. §119 of U.S. Provisional Application Ser. No. 61/603581 filed on Feb. 27, 2012 the content of which is relied upon and incorporated herein by reference in its entirety.

### FIELD

This disclosure relates generally to glass fining methods and more particularly to glass fining methods including bubbling which may be used in low cost glass manufacturing.

### TECHNICAL BACKGROUND

Gaseous inclusions are usually generated during the melting of a glass by reaction of the raw materials under heat. The gaseous inclusions may then be removed in various ways. Four general types of bubble removal include: a large melting vessel wherein batch materials are added in the rear of the vessel, closer to the front of the vessel a free-surface exists, and the bubbles in the glass are removed when they rise to the surface of the glass and pop; or batch is fed into the rear of the melting vessel, the glass is moved to a fining vessel which is higher in temperature than the melting vessel, and the bubbles rise to the surface and pop; or batch is fed into the rear of the melting vessel, the glass is moved to a fining vessel which is higher in temperature than the melting vessel, and a chemical fining agent is added to the batch so that at higher temperature, when the glass reaches the fining vessel the fining agent releases gas, increasing the existing bubble sizes to improve the rise rate, thereby improving the fining; or batch is fed into the rear of the melting vessel, the glass is moved to a fining vessel which is higher in temperature than the melting vessel, and a vacuum is pulled above the glass surface in the fining vessel which causes the bubbles to grow in response, rise to the surface and pop.

A lot of the gaseous inclusions may be removed using the above methods with varying success depending on the particulars of the equipment, glass composition, and operation setup. There exists a need for a method of fining which is low cost and/or minimizes gaseous inclusions.

### SUMMARY

In methods of making glass, for example, where the glass is moved from a melting vessel to a fining vessel, forced bubbling (which may be a single bubbler, row of bubblers or multiple rows of bubblers) may be placed in the fining vessel to improve the fining, for example, the minimization or elimination of bubbles.

One embodiment is a method for fining a glass melt, the method comprises providing a glass melt in a melting vessel, moving the glass melt to a fining vessel via a first channel, and physically introducing gas bubbles to the glass melt in the fining vessel to form a fined glass, wherein the melting vessel and the fining vessel are in a horizontal orientation with respect to each other.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a schematic illustrating the method according to one embodiment.

FIG. 2 is a graph of math modeling results showing blister (gaseous inclusion) elimination distance.

FIG. 3A shows the glass flow and temperature without bubbling in a fining vessel.

FIG. 3B shows the glass flow and temperature with bubbling in a fining vessel.

### DETAILED DESCRIPTION

Embodiments may provide one or more advantages such as increasing the throughput of the glass fined through the fining vessel to get equivalent quality to that without the bubbler(s), in the case of an existing process, this may increase the total sales off an existing equipment footprint causing a reduction in the cost/unit. In the case of a new process, this could allow a smaller, less expensive fining vessel to be built for net capital savings. Further, this could allow the decreasing of the minimum gaseous inclusion size which can be removed from the fining vessel which may be used to decrease the allowable gaseous inclusion size of the glass product in order to provide superior quality with no increase in losses. Also, this could allow the increasing of the total number of gaseous inclusions which may be removed by fining and thus may be used to reduce the footprint of the melting vessel, increasing the bubble loading to the fining vessel with no increase in losses or worsening of quality.

One embodiment, as shown in FIG. 1, is a method 100 for fining a glass melt, the method comprises providing a glass melt 10 in a melting vessel 12, moving the glass melt to a fining vessel 14 via a first channel 16, and physically introducing gas bubbles 18 to the glass melt in the fining vessel to form a fined glass 11, wherein the melting vessel and the fining vessel are in a horizontal orientation with respect to each other.

According to one embodiment, physically introducing gas bubbles to the glass melt comprises generating bubbles in the glass melt via at least one bubbler 20. A single bubbler, row of bubblers or multiple rows of bubblers may be placed in the rear of the fining vessel to improve the fining, for example, the minimizing of gaseous inclusions.

In one embodiment, the moving the glass melt comprises moving the glass melt into a portion 22 of the fining vessel above the bubbler. The bubbles create an upward force at the entrance of the fining vessel, whereby the gaseous inclusions entering the vessel via the first channel 16 from the melting vessel are pulled in the upward direction faster than by Stokes Law (bubble rise) alone. Therefore, the gaseous inclusions reach the surface of the glass faster than they would without bubbling, removing gaseous inclusions more efficiently.

In one embodiment, the bubbler, row of bubblers or multiple rows of bubblers are placed in the rear of the fining vessel. In one embodiment, the fining vessel is of a high aspect ratio, for example, at least 1.5 times length compared to width, for example, 1.5 times length, for example, 1.6 times length, for example, 1.7 times length, for example, 1.8 times length, for example, 1.9 times length, for example, 2.0 times length, for example, 1.5 times to 2.0 times length. Rear bubbling combined with high aspect ratio of the fining vessel creates a condition whereby the thermal convection of the glass is not greatly disturbed.

The melting vessel may be made of ceramic refractory blocks and may or may not be lined with platinum or a platinum alloy. In one embodiment, the method further comprises heating the glass melt in the melting vessel. The melting vessel is heated by any number of methods including sidewall or bottom electrodes used alone or in combination with gas/oxygen or gas/air burners placed in the sidewall above the glass melt.

In one embodiment, a first channel, for example a tube, made of ceramic refractory delivers glass from the melting vessel to the fining vessel. The channel may also comprise platinum or a platinum alloy, backed with ceramic refractory material for strength. In one embodiment, the method further comprises heating the glass melt in the first channel. The first channel may be indirectly heated using heating elements or direct heat of the platinum for example, platinum tube, depending on the design of the channel. In the case of a refractory channel, it will be heated with heated element electrodes under glass or burners above the glass, or a mixture of both.

The fining vessel may be made of ceramic refractory which may or may not be lined with platinum or a platinum alloy. In one embodiment, the method further comprises heating the glass melt in the fining vessel. The fining vessel is heated by any number of methods including sidewall or bottom electrodes used alone or in combination with gas/oxygen or gas/air burners placed in the sidewall above the glass melt.

The bubbler elements may be made in a number of configurations including: one bubbler at the rear of the fining vessel; a row of bubblers at the rear of the vessel; or multiple rows of bubblers at the rear of the vessel.

The bubblers may bubble different gas compositions with similar effect because the effect is physical. Some example bubble gasses include O₂, Air, N₂, Ar or combinations thereof. One gas may be preferred over another based on the materials used in the vessel as well as the glass composition—O₂ and Air could oxidize the glass or refractory materials and N₂ or Ar could reduce fining agents (such as arsenic or antimony) in the glass. Therefore, it is likely that one would tailor the gas composition to the glass composition and material selection—all combinations which result in improved fining via forced bubbling in the fining vessel are intended to be covered.

In some embodiments, the bubbling rate is relatively low, for example, 12-30 bubbles/minute, and still allows for physical mixing of the glass. In some embodiments, the bubbling rate is 12-60 bubbles/minute. At 60 bubbles/minute the fining improvement may decrease, though it is still better than no bubbling.

In some embodiments, the bubbles have an average diameter in the range of from 0.5 to 3 inches, for example, 1 to 3 inches, for example, 1 to 2.5 inches, for example, 1 to 2 inches.

In some embodiments, the physically introducing gas bubbles comprises introducing bubbles at a bubbling rate in the range of from 12 to 60 bubbles per minute and the bubbles have an average diameter in the range of from 0.5 to 3 inches.

The method, according to one embodiment, further comprises moving the fined glass to a forming process via a second channel 24. The second channel, for example a tube, may be made of ceramic refractory. The second channel may comprise platinum or a platinum alloy, backed with ceramic refractory material, for example, for strength. The method, according to some embodiments, further comprises heating the glass melt in the second channel. The second channel may be heated using heating elements, windings or direct heating of the platinum, for example, tube, depending on the design of the channel.

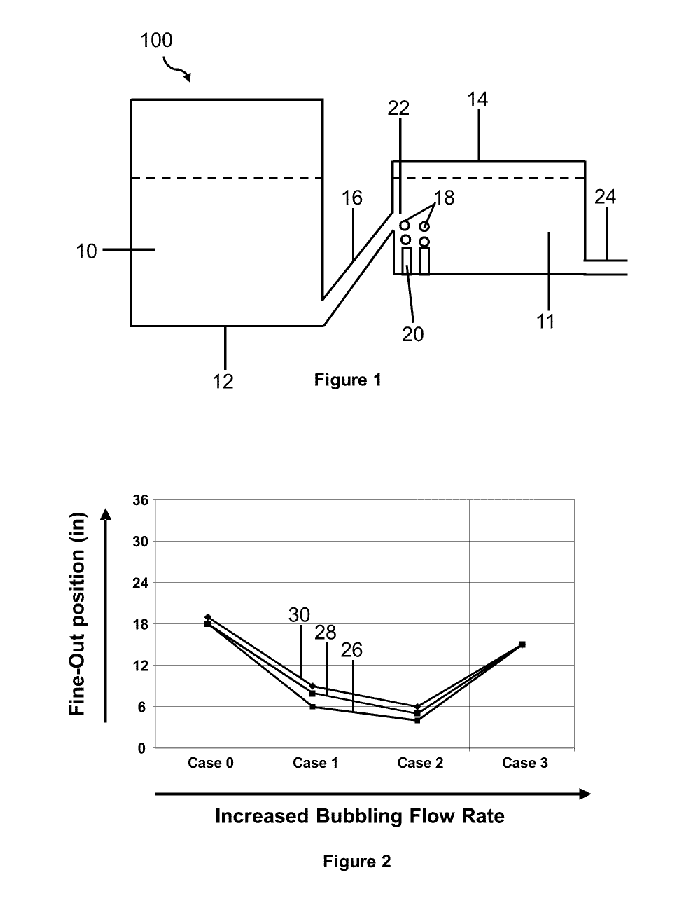

FIG. 2 is a graph of math modeling results showing that the blister (gaseous inclusion) elimination distance is decreased by bubbling in the rear of the fining vessel. For this example, the optimum bubbling rate is below 30 bubbles per minute. 12 bubbles per minute also show very good results. Above this rate, the fining improvement starts to decrease. FIG. 2 shows the resulting fine out position of various cases using math modeling: Case 0 is no bubbling, Case 1 is bubbling 12 bubbles/min with 1 inch bubbles, Case 2 is bubbling 12 bubbles/min with 2 inch bubbles and Case 3 is bubbling 30 bubbles/min with 2 inch bubbles. The smaller the fine out position (the distance down the vessel at which all the launched bubbles are removed), the better the fining of the vessel. Lines 26, 28, and 30 show increasing lbs/hr at the same tank depth. Therefore, the advantages shown by the graph in FIG. 2 are the following: fining is improved by bubbling, and there is an optimum bubbling rate; bubbling at a low rate improves fining, increasing that bubbling rate will eventually cause worse fining, though it still may be preferable to no fining.

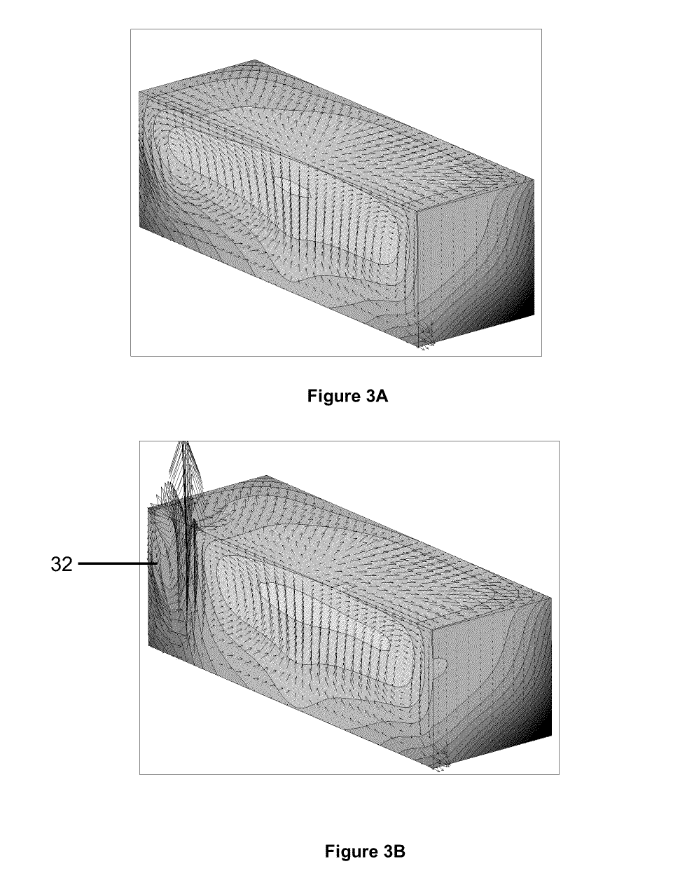

FIG. 3A shows the glass flow and temperature without bubbling in a fining vessel. The lighter the shade of gray, the higher the temperature.

FIG. 3B shows the glass flow and temperature with bubbling in a fining vessel. The lighter the shade of gray, the higher the temperature. In the case with bubbling, there is a very pronounced upward force at the rear of the vessel 32. This upward force may increase the flow of bubbles (or blister defects) upward to the surface of the glass which allows them more time to fine out (popping at the surface of the melt).

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A method for fining a glass melt, the method comprising:
providing a glass melt in a melting vessel;
moving the glass melt to a fining vessel via a first channel; and
physically introducing gas bubbles to the glass melt in the fining vessel to form a fined glass, wherein the melting vessel and the fining vessel are in a horizontal orientation with respect to each other.

2. The method according to claim 1, wherein the physically introducing gas bubbles to the glass melt comprises generating bubbles in the glass melt via at least one bubbler.

3. The method according to claim 2, wherein the moving the glass melt comprises moving the glass melt into a portion of the fining vessel above the bubbler.

4. The method according to claim 2, comprising generating bubbles in the glass melt via a plurality of bubblers.

5. The method according to claim 4, wherein the bubblers comprise a row of bubblers or multiple rows of bubblers.

6. The method according to claim 4, wherein the moving the glass melt comprises moving the glass melt into a portion of the fining vessel above the bubblers.

7. The method according to claim 1, further comprising moving the fined glass to a forming process via a second channel.

8. The method according to claim 1, wherein the physically introducing gas bubbles comprises passing air, O₂, N₂, Ar, or a combination thereof through at least one bubbler and into the glass melt.

9. The method according to claim 1, wherein the physically introducing gas bubbles comprises introducing bubbles at a bubbling rate in the range of from 12 to 60 bubbles per minute.

10. The method according to claim 9, wherein the bubbles have an average diameter in the range of from 0.5 to 3 inches.

11. The method according to claim 1, wherein the fining vessel has a length at least 1.5 times its width.

12. The method according to claim 1, further comprising heating the glass melt in the melting vessel.

13. The method according to claim 1, further comprising heating the glass melt in the fining vessel.

14. The method according to claim 1, further comprising heating the glass melt in the first channel.

15. The method according to claim 1, further comprising heating the fined glass in the second channel.
